(19) United States
(12) Patent Application Publication
(10) Pub. No.: US 2025/0369486 A1
(43) Pub. Date: Dec. 4, 2025

(54) CONNECTION SYSTEM FOR PLUNGER PUMP DEVICE

(71) Applicant: YANTAI JEREH OILFIELD SERVICES GROUP CO., LTD., Yantai (CN)

(72) Inventors: Junlei YAO, Yantai (CN); Qianjie LI, Yantai (CN); Maoqin LI, Yantai (CN)

(73) Assignee: YANTAI JEREH OILFIELD SERVICES GROUP CO., LTD., Yantai (CN)

(21) Appl. No.: 19/213,648

(22) Filed: May 20, 2025

Related U.S. Application Data
(63) Continuation of application No. PCT/CN2024/132308, filed on Nov. 15, 2024.

(30) Foreign Application Priority Data
May 28, 2024 (CN) 202421187956.2

(51) Int. Cl. F16D 3/06; F04B 9/02

(52) U.S. Cl. CPC F16D 3/06; F04B 9/02; F16D 3/185; F04B 2201/124

(57) ABSTRACT

A connection system for a plunger pump device, includes: a connector, including a shaft and first and second engaging portions provided at opposite end portions of the shaft; a reduction gearbox interface including a third engaging portion; and a plunger pump device interface including a fourth engaging portion. The first engaging portion engages with the third engaging portion to form a first engaging pair, and the second engaging portion engages with the fourth engaging portion to form a second engaging pair. The first and third engaging portions are respectively internal teeth and external teeth of the first engaging pair, or are respectively external teeth and internal teeth of the first engaging pair. The second and fourth engaging portions are respectively internal teeth and external teeth of the second engaging pair, or are respectively external teeth and internal teeth of the second engaging pair.

### CROSS-REFERENCE TO RELATED APPLICATIONS

This application is based on and claims the benefit of priority to PCT International Patent Application No. PCT/CN2024/132308, filed on Nov. 15, 2024, which is based on and claims the benefit of priority to Chinese Patent Application No. 202421187956.2, filed on May 28, 2024, each of which are hereby fully incorporated by reference herein in their entirety.

### TECHNICAL FIELD

The present disclosure relates to a connection system for a plunger pump device, and in particular, to a connection system for connecting a reduction gearbox to a plunger pump device for power transmission.

### BACKGROUND

It is well known that in the field of petroleum plunger pump device, power sources such as diesel engines and electromotors provide power input to the plunger pump device through a reduction gearbox. Typically, reduction gearbox-side splines provided on the reduction gearbox and plunger pump device-side splines provided on the plunger pump device are directly engaged to implement power transmission between them.

When ordinary splines are engaged to operate, straight internal teeth and straight external teeth are engaged, and in an ideal condition, a contact surface between the internal teeth and the external teeth is a line. However, when a small skew angle occurs in the spline engagement, this results in stress concentration in a contact area. In addition, long-term engagement may cause tooth surface wear, and in severe cases, cracking, pitting, tooth breaking, and the like may occur. Thus, a service life of the spline is greatly reduced.

### SUMMARY

In view of the foregoing, the present disclosure provides a connection system for connecting a reduction gearbox to a plunger pump device to implement power transmission between the reduction gearbox and the plunger pump device. The connection system can eliminate the foregoing disadvantages of the prior art while bringing other advantages.

A connection system for a plunger pump device according to the present disclosure includes: a connector, including a shaft and a first engaging portion and a second engaging portion provided at opposite end portions of the shaft; a reduction gearbox interface, including a third engaging portion; and a plunger pump device interface, including a fourth engaging portion. The first engaging portion engages with the third engaging portion to form a first engaging pair, and the second engaging portion engages with the fourth engaging portion to form a second engaging pair. The first engaging portion and the third engaging portion are respectively internal teeth and external teeth of the first engaging pair, or are respectively external teeth and internal teeth of the first engaging pair. The second engaging portion and the fourth engaging portion are respectively internal teeth and external teeth of the second engaging pair, or are respectively external teeth and internal teeth of the second engaging pair. The external teeth or the internal teeth of the first engaging pair are configured as crowned teeth, and/or the external teeth or the internal teeth of the second engaging pair are configured as crowned teeth. Other external teeth and internal teeth of the first engaging pair and the second engaging pair are configured as straight teeth.

According to a preferred embodiment, a size of the second engaging portion is configured for a reduction gearbox with specific power.

According to a preferred embodiment, the shaft is configured in a form of a straight shaft or a stepped shaft.

According to a preferred embodiment, the shaft is configured as a hollow shaft having an axial through hole.

According to a preferred embodiment, the connection system further includes a limiting mechanism fastened to one or both of the plunger pump device interface and the reduction gearbox interface to limit axial displacement of the connector between the plunger pump device interface and the reduction gearbox interface.

According to a preferred embodiment, the limiting mechanism is an L-shaped plate and includes a first leg and a second leg perpendicular to the first leg, the shaft is provided with a notch on a periphery, the first leg is fastened to one or both of the plunger pump device interface and the reduction gearbox interface, and the second leg is accommodated in the notch to limit bidirectional displacement of the connector in an axial direction.

According to a preferred embodiment, an axial size of the notch is configured to be greater than an axial size of the second leg to provide an allowable axial displacement amount of the connector.

According to a preferred embodiment, the connection system further includes a limiting mechanism, the limiting mechanism includes a stepped member and an auxiliary limiting member, the stepped member is fastened to a first end portion of the connector to limit displacement of the connector in a first direction of an axial direction, and the auxiliary limiting member is fastened to a second end portion of the connector opposite to the first end portion to limit displacement of the connector in a second direction of the axial direction.

According to a preferred embodiment, the stepped member includes a body and a stepped portion having a radial size smaller than that of the body, and the stepped portion is configured to have a specific axial thickness to provide an allowable axial displacement amount of the connector.

According to a preferred embodiment, the allowable axial displacement amount is 2 mm to 8 mm.

According to a preferred embodiment, the plunger pump device interface is a crankcase interface provided on a crankcase of the plunger pump device.

### BRIEF DESCRIPTION OF THE DRAWINGS

The accompanying drawings of this specification constituting a part of this application are used to provide a further understanding of the present disclosure. Schematic embodiments of the present disclosure and descriptions thereof are used to explain the present disclosure, and do not constitute an improper limitation on the present disclosure.

FIG. 1 is a cross-sectional view of a connection system according to a first embodiment of the present disclosure.

FIG. 2 is a cross-sectional view of a connector in the connection system according to the first embodiment of the present disclosure.

FIG. 3 is a plan view of the connector in the connection system according to the first embodiment of the present disclosure.

FIG. 4 is an end view of the connector in the connection system according to the first embodiment of the present disclosure.

FIG. 5 is a three-dimensional view of the connector in the connection system according to the first embodiment of the present disclosure.

FIG. 6 is a cross-sectional view of another example of the connector in the connection system according to the first embodiment of the present disclosure.

FIG. 7 is a plan view of another example of the connector in the connection system according to the first embodiment of the present disclosure.

FIG. 8 is an end view of another example of the connector in the connection system according to the first embodiment of the present disclosure.

FIG. 9 and FIG. 10 are three-dimensional views of another example of the connector in the connection system according to the first embodiment of the present disclosure.

FIG. 11 is a cross-sectional view of a connector in a connection system according to a second embodiment of the present disclosure.

FIG. 12 is an end view of the connector in the connection system according to the second embodiment of the present disclosure.

FIG. 13 is a three-dimensional view of the connector in the connection system according to the second embodiment of the present disclosure.

FIG. 14 is a cross-sectional view of the connector shown in FIG. 2 to FIG. 5 in a state of engaging with a reduction gearbox interface and a plunger pump device interface.

FIG. 15 is a cross-sectional view of the connector shown in FIG. 6 to FIG. 10 in a state of engaging with a reduction gearbox interface and a plunger pump device interface.

FIG. 16 is a partially enlarged view of a part A of FIG. 15.

FIG. 17 shows a separate stepped member used as a limiting member.

### DETAILED DESCRIPTION

To make the objectives, technical solutions, and advantages of this application clearer, the following further describes this application in detail with reference to the accompanying drawings and embodiments. It should be understood that the specific embodiments described herein are merely intended to explain this application, and are not intended to limit this application.

### First Embodiment

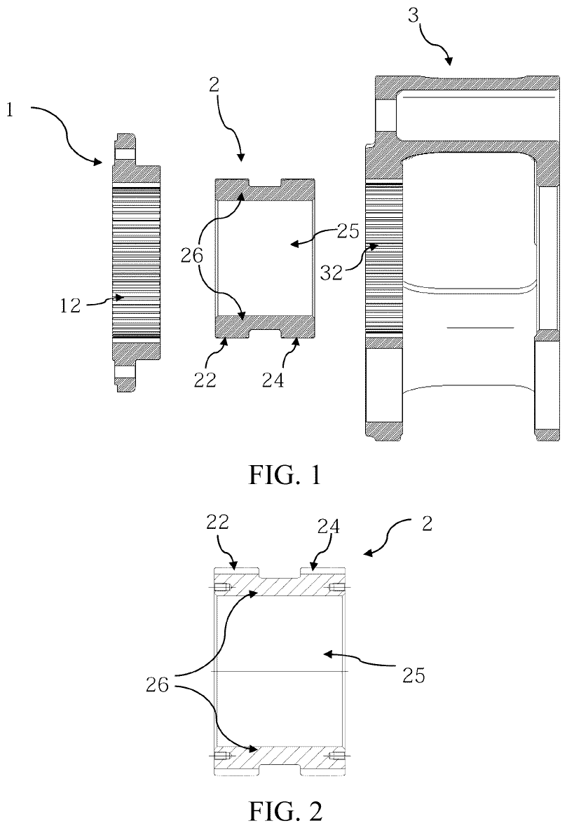

FIG. 1 is a cross-sectional view of a connection system according to the first embodiment of the present disclosure.

As shown in FIG. 1, the connection system according to this embodiment includes a reduction gearbox interface 1 arranged on a reduction gearbox, a connector 2, and a plunger pump device interface 3 arranged on a plunger pump device. For example, the plunger pump device interface 3 may be a crankcase interface arranged on a crankcase serving as a plunger pump device, such as an internal ring gear at a crankshaft end portion.

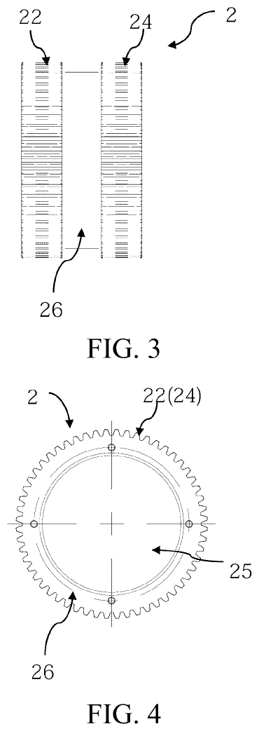

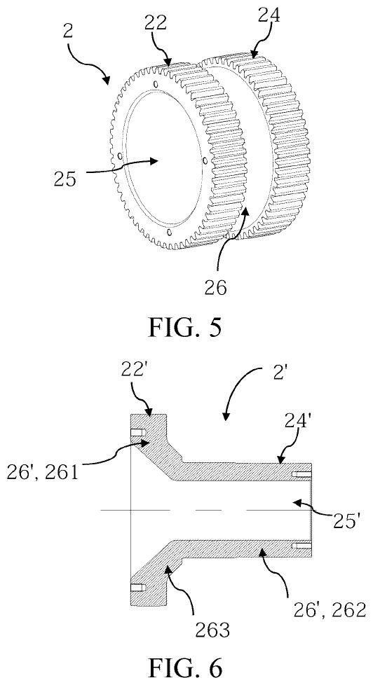

In addition, FIG. 2 is a cross-sectional view of the connector 2 in the connection system according to this embodiment. FIG. 3 is a plan view of the connector 2 in the connection system according to this embodiment. FIG. 4 is an end view of the connector 2 in the connection system according to this embodiment. FIG. 5 is a three-dimensional view of the connector 2 in the connection system according to this embodiment.

As shown in FIG. 2 to FIG. 5, the connector 2 is configured to have a first engaging portion 22, a second engaging portion 24, and a shaft 26. The first engaging portion 22 and the second engaging portion 24 of the connector 2 are fastened at opposite end portions of the shaft 26. In this embodiment, the first engaging portion 22 is teeth arranged on an outer circumference of a first end portion (the left end portion in FIG. 1) of the shaft 26. The second engaging portion 24 is teeth arranged on an outer circumference of a second end portion (the right end portion in FIG. 1) of the shaft 26. In this specification, teeth arranged on an outer circumference are referred to as external teeth.

To implement power transmission by respectively engaging the connector 2 with the reduction gearbox interface 1 and the plunger pump device interface 3, the reduction gearbox interface 1 is configured to have a reduction gearbox engaging portion 12, and the plunger pump device interface 3 is configured to have a plunger pump device engaging portion 32. In a manner corresponding to the first engaging portion 22 and the second engaging portion 24 of the connector 2, both the reduction gearbox engaging portion 12 of the reduction gearbox interface 1 and the plunger pump device engaging portion 32 of the plunger pump device interface 3 are configured as teeth arranged on inner circumferences of corresponding interfaces. Specifically, each of the reduction gearbox interface 1 and the plunger pump device interface 3 may include a notch or a through hole, and the reduction gearbox engaging portion 12 and the plunger pump device engaging portion 32 may be correspondingly arranged as teeth on an inner circumference of the notch or the through hole. In this specification, teeth arranged on an inner circumference are referred to an internal teeth.

In this embodiment, as shown in FIG. 2 to FIG. 5, the shaft 26 is shown as a straight shaft. The shaft 26 is a rigid shaft, and can implement power transmission between the first engaging portion 22 and the second engaging portion 24.

In addition, to reduce weight, the shaft 26 may further include an axial through hole 25. For example, in FIG. 2, the axial through hole 25 penetrates from the left end of the shaft 26 to the right end of the shaft 26. That is, the shaft 26 is in the form of a hollow shaft. For example, a ratio of a diameter of a through hole to a diameter of a tooth tip circle is in a range of 0.6 to 0.8, and a ratio of a minimum wall thickness of the shaft 26 to a diameter of the tooth tip circle is in a range of 0.06 to 0.15.

In addition, because the connector 2 is applied to the plunger pump device, and therefore a torque transmitted is extremely large, large fillets with radii ranging from R10 to R20 may be used to transition between positions of the engaging portions 22 and 24 of the shaft 26 and nearby regions. Roughness of the fillet may be configured as Ra0.8 to Ra3.2, and the connector 2 is processed in a forged integral molding manner, and a length-to-diameter ratio may be in a range of 0.5 to 1.

During operation of the plunger pump device, the reduction gearbox engaging portion 12 of the reduction gearbox interface 1 engages with the first engaging portion 22 of the connector 2. In this case, the reduction gearbox engaging portion 12 of the reduction gearbox interface 1 forms a first engaging pair with the first engaging portion 22 of the connector 2.

In addition, the plunger pump device engaging portion 32 of the plunger pump device interface 3 engages with the second engaging portion 24 of the connector 2. In this case, the plunger pump device engaging portion 32 of the plunger pump device interface 3 forms a second engaging pair with the second engaging portion 24 of the connector 2.

Therefore, power from a power source can be transmitted to the plunger pump device by using the connection provided by the connector 2 through the reduction gearbox. For example, in the meaning of this application, the plunger pump device may be a device used for a plunger pump or a part of the plunger pump. For example, the plunger pump device may be a crankcase used for the plunger pump.

According to the present disclosure, to reduce tooth surface wear during operation, the first engaging portion 22 and the second engaging portion 24 of the connector 2, both configured as external teeth, are configured as crowned teeth. Correspondingly, the reduction gearbox engaging portion 12 of the reduction gearbox interface 1 as internal teeth and the plunger pump device engaging portion 32 of the plunger pump device interface 3 as internal teeth are configured as straight teeth. It is well known that when teeth have a linear profile within an operating pitch plane, they are referred to as straight teeth. In addition, when teeth have a curved tooth profile in the operating pitch plane, they are referred to as crowned teeth.

Therefore, the connection system according to this example uses a connection manner in which straight teeth (for example, the reduction gearbox engaging portion 12 of the reduction gearbox interface 1 and the plunger pump device engaging portion 32 of the plunger pump device interface 3) engage with crowned teeth (for example, the first engaging portion 22 and the second engaging portion 24 of the connector 2). When two tooth surfaces of the straight teeth and crowned teeth experience a slight skew angle, their contact surface does not change significantly. Therefore, under prolonged engagement, the tooth surfaces maintain good contact, and compared to engagement of straight teeth, the condition of the contact surface is significantly improved. Therefore, in the connection system according to this embodiment, an extreme phenomenon such as tooth breaking, cracking, and pitting does not occur, and only normal tooth surface wear occurs, greatly improving its service life.

It should be noted that the technical term “engaging portion” used in this application should be understood broadly, and a scope thereof may vary according to development of the technology. Specifically, the engaging portion refers to a part configured to implement power transmission between two mechanical parts. The two mechanical parts have respective engaging portions, and these engaging portions may be engaged with each other to implement mechanical power transmission or engaging power transmission. For example, in the present disclosure, the engaging portion may be implemented in the form of teeth.

### Variant of the Connector

In different application scenarios, there are reduction gearboxes that use different power to implement power input of a power source to a fracturing device. However, there is a problem of non-uniform sizes of reduction gearbox-side splines of reduction gearboxes with different power. Therefore, it is difficult to connect reduction gearboxes with different power to the fracturing device in the platform.

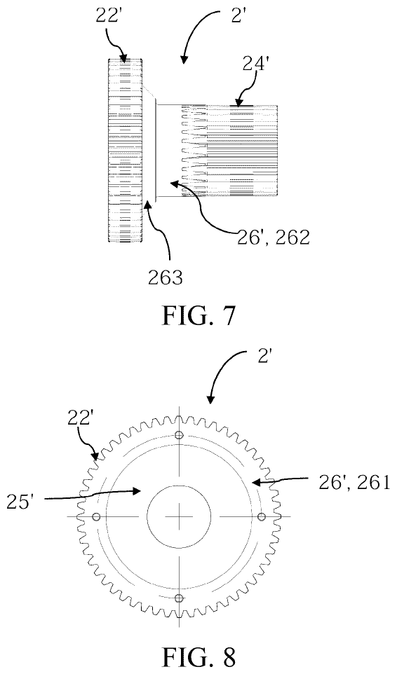

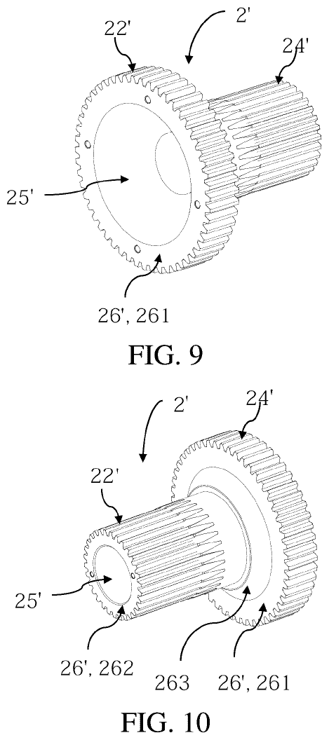

FIG. 6 is a cross-sectional view of another example of the connector in the connection system according to the first embodiment of the present disclosure. FIG. 7 is a plan view of another example of the connector in the connection system according to the first embodiment of the present disclosure. FIG. 8 is an end view of another example of the connector in the connection system according to the first embodiment of the present disclosure. FIG. 9 and FIG. 10 are three-dimensional views of another example of the connector in the connection system according to the first embodiment of the present disclosure.

A connector 2′ according to this example is a variant of the connector 2.

A first engaging portion 22′ of the connector 2′ may have the same size (for example, a base circle diameter) as the first engaging portion 22 of the connector 2, and therefore can also engage with the plunger pump device engaging portion 32 of the plunger pump device interface 3 shown in FIG. 1. However, a second engaging portion 24′ of the connector 2′ has a different size (for example, a base circle diameter) from the second engaging portion 24 of the connector 2, and thus can be used for reduction gearbox engaging portions with different sizes of reduction gearbox interfaces of reduction gearboxes with different power. In this example, the size of the second engaging portion 24′ of the connector 2′ is smaller than the size of the second engaging portion 24 of the connector 2. That is, the sizes of the second external teeth 24 and 24′ of the connectors 2 and 2′ are configured and selected for a reduction gearbox with specific power.

In this case, as shown in FIG. 6 and FIG. 7, a shaft 26′ is configured as a stepped shaft. Specifically, the shaft 26′ may include a large-sized portion 261 and a small-sized portion 262. The large-sized portion 261 and the small-sized portion 262 may be respectively in the form of a straight shaft, and they are concentrically connected to each other or integrally formed in a concentric manner. To fit the sizes of the engaging portions 22′ and 24′, as shown in FIG. 6, the radial size of the large-sized portion 261 is greater than the radial size of the small-sized portion 262.

The first engaging portion 22′ of the connector 2′ is arranged as external teeth on an outer circumference of the large-sized portion 261. In addition, the second engaging portion 24′ of the connector 2′ is arranged as external teeth on an outer circumference of an end portion of the small-sized portion 262 that is opposite to the large-sized portion.

In addition, to reduce the weight of the connector 2′, as shown in FIG. 6, the axial size of the large-sized portion 261 is far smaller than the axial size of the small-sized portion 262. The axial size of the large-sized portion 261 may be set so that the first engaging portion 22′ of the connector 2′ can be arranged on the large-sized portion 261.

In addition, the shaft 26′ may further include a transition portion 263 in the form of a fillet. The transition portion 263 is arranged at a boundary between the large-sized portion 261 and the small-sized portion 262 to reduce stress concentration.

For example, similar to the connector 2 shown in FIG. 1 to FIG. 5, the connector 2′ in this example may also include an axial through hole 25′ to reduce the weight of the connector 2′.

Another aspect of this variant is the same as that in the examples shown in FIG. 1 to FIG. 5.

Therefore, the connection system according to this embodiment allows different reduction gearboxes to be connected to the plunger pump device in the same platform by directly replacing a corresponding connector. Therefore, this design provides convenience for connections between different devices in the platform, ensures subsequent development of different reduction gearboxes, and promotes platform development.

### Second Embodiment

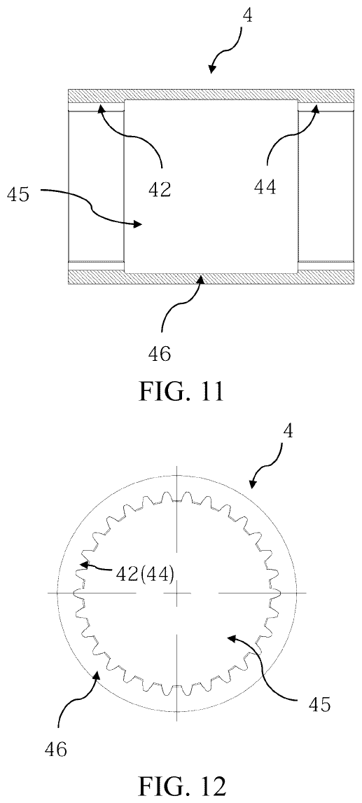

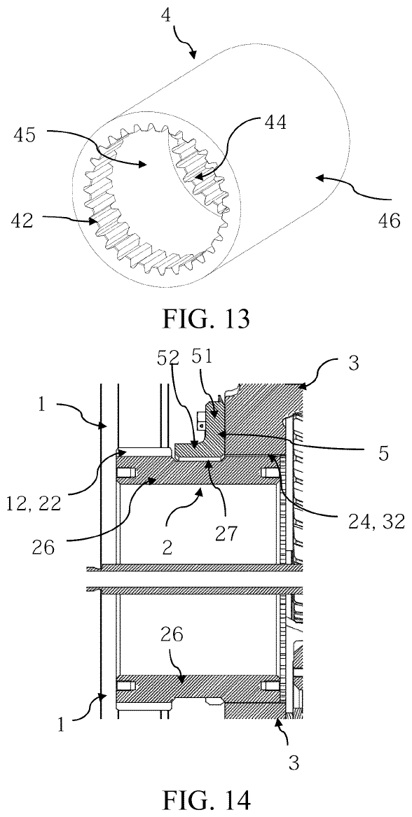

FIG. 11 is a cross-sectional view of a connector 4 in a connection system according to the second embodiment of the present disclosure. FIG. 12 is an end view of the connector 4 in the connection system according to the second embodiment of the present disclosure. FIG. 13 is a three-dimensional view of the connector 4 in the connection system according to the second embodiment of the present disclosure.

As shown in FIG. 11 to FIG. 13, the connector 4 is configured to have a first engaging portion 42, a second engaging portion 44, and a shaft 46. The first engaging portion 42 and the second engaging portion 44 of the connector 4 are fastened at opposite end portions of the shaft 46. As in the first embodiment, in this embodiment, the shaft 46 may also be configured as a straight shaft.

In addition, similar to the first embodiment, to reduce weight, the shaft 46 may further include an axial through hole 45. For example, in FIG. 11, the axial through hole 45 penetrates from the left end of the shaft 46 to the right end of the shaft 46. That is, the shaft 46 is in the form of a hollow shaft.

During operation of the plunger pump device, the reduction gearbox engaging portion (not shown) of the reduction gearbox interface 1 engages with the first engaging portion 42 of the connector 4. In this case, the reduction gearbox engaging portion of the reduction gearbox interface 1 forms a first engaging pair with the first engaging portion 42 of the connector 4.

In addition, the plunger pump device engaging portion (not shown) of the plunger pump device interface 3 engages with the second engaging portion 44 of the connector 4. In this case, the plunger pump device engaging portion of the plunger pump device interface 3 forms a second engaging pair with the second engaging portion 44 of the connector 4.

In this embodiment, as shown in FIG. 11 to FIG. 13, both the first engaging portion 42 and the second engaging portion 44 of the connector 4 are configured as internal teeth. For engagement, both the reduction gearbox engaging portion (not shown) of the reduction gearbox interface 1 and the plunger pump device engaging portion (not shown) of the plunger pump device interface 3 are correspondingly configured as external teeth.

In addition, preferably, the length-to-diameter ratio of the connector 4 may be 0.5 to 1, and the ratio of the outer diameter of the connector 4 to the diameter of the tooth tip circle may be in a range of 1.1 to 1.3.

According to the present disclosure, to reduce tooth surface wear during operation, the first engaging portion 42 and the second engaging portion 44 of the connector 4 as internal teeth are configured as straight teeth. Correspondingly, the reduction gearbox engaging portion of the reduction gearbox interface 1 as external teeth and the plunger pump device engaging portion of the plunger pump device interface 3 as external teeth are configured as crowned teeth.

Therefore, the connection system according to this example uses a connection manner in which straight teeth (for example, the first engaging portion 42 and the second engaging portion 44 of the connector 4) engage with crowned teeth (for example, the reduction gearbox engaging portion of the reduction gearbox interface 1 and the plunger pump device engaging portion of the plunger pump device interface 3). When two tooth surfaces of the straight teeth and crowned teeth experience a slight skew angle, their contact surface does not change significantly. Therefore, under prolonged engagement, the tooth surfaces maintain good contact, and compared to engagement of straight teeth, the condition of the contact surface is significantly improved. Therefore, in the connection system according to this embodiment, an extreme phenomenon such as tooth breaking, cracking, and pitting does not occur, and only normal tooth surface wear occurs, greatly improving its service life.

In addition, the size of the second engaging portion 44 of the connector 4 may also be configured and selected for a reduction gearbox with specific power. In this case, the shaft 46 may be configured as a stepped shaft.

Another aspect of this embodiment is the same as that of the first embodiment.

Therefore, the connection system according to this embodiment allows different reduction gearboxes to be connected to the plunger pump device in the same platform by directly replacing a corresponding connector. Therefore, this design provides convenience for connections between different devices in the platform, ensures subsequent development of different reduction gearboxes, and promotes platform development.

### Other Variants

The foregoing embodiment describes cases in which all external teeth in the first engaging pair and the second engaging pair are configured as crowned teeth and all internal teeth therein are configured as straight teeth. However, the present disclosure is not limited to these cases.

According to an improved example as a variant, for example, in the first engaging pair and the second engaging pair, the external teeth may all be configured as straight teeth, and the internal teeth may all be configured as crowned teeth.

Alternatively, according to an improved example as a variant, for example, in the first engaging pair, the external teeth may be configured as straight teeth, and the internal teeth may be configured as crowned teeth, while in the second engaging pair, the external teeth may be configured as crowned teeth, and the internal teeth may be configured as straight teeth.

Alternatively, according to an improved example as a variant, for example, in the first engaging pair, the external teeth may be configured as crowned teeth, and the internal teeth may be configured as straight teeth, while in the second engaging pair, the external teeth may be configured as straight teeth, and the internal teeth may be configured as crowned teeth.

Alternatively, according to an improved example as a variant, in one of the first engaging pair and the second engaging pair, the external teeth may be configured as crowned teeth, and the internal teeth may be configured as straight teeth, and in the other engaging pair, both the external teeth and the internal teeth are configured as straight teeth.

Alternatively, according to an improved example as a variant, in one of the first engaging pair and the second engaging pair, the external teeth may be configured as straight teeth, and the internal teeth may be configured as crowned teeth, and in the other engaging pair, both the external teeth and the internal teeth are configured as straight teeth.

Thus, connection systems according to these improved examples employ a connection manner in which straight teeth engage with crowned teeth, and thus the same technical effects as those of the foregoing embodiments can be obtained.

### Limiting Mechanism

During operation of the plunger pump device, in the examples shown in FIG. 2 to FIG. 5, the connector 2 may have excessive axial float between the reduction gearbox interface 1 and the plunger pump device interface 3. When the connector is biased toward one of the two, the actual contact area of the crowned teeth becomes narrower, which further affects contact strength. Therefore, the axial position limiting problem needs to be considered.

FIG. 14 is a cross-sectional view of the connector 2 shown in FIG. 2 to FIG. 5 in a state of engaging with the reduction gearbox interface 1 and the plunger pump device interface 3.

As shown in FIG. 14, a limiting mechanism is fastened on the plunger pump device interface 3. The limiting mechanism is, for example, in the form of an L-shaped plate 5. For example, one leg 51 of two legs of the L-shaped plate 5 is fastened to the plunger pump device interface 3 through a bolted connection.

In addition, between the two engaging portions 22 and 24 of the connector 2, a notch 27 is arranged on the outer circumference of the shaft 26. The other leg 52 of the two legs of the L-shaped plate 5 that is perpendicular to the leg 51 is accommodated in the notch 27 in a non-fastened manner.

The axial size of the leg 52 of the L-shaped plate 5 and the axial size of the notch 27 are set so that the leg 52 can be displaced by a certain axial displacement amount in the axial direction in the notch 27. The axial direction is the horizontal direction in FIG. 5. For example, the axial size of the notch 27 may be slightly greater than the axial size of the leg 52 of the L-shaped plate 5 to provide an allowable axial displacement amount of the connector 2. The allowable axial displacement amount may be, for example, 2 mm to 8 mm. That is, the axial displacement of the L-shaped plate 5 is limited by the shape of the notch 27, so that the axial displacement amount of the L-shaped plate 5 in the notch 27 always falls within the allowable axial displacement amount.

In the example shown in FIG. 14, the L-shaped plate 5 is fastened to the plunger pump device interface 3. However, the present disclosure is not limited to this fastening manner. For example, the L-shaped plate 5 may alternatively be fastened to the reduction gearbox interface 1 or both the reduction gearbox interface 1 and the plunger pump device interface 3.

By arranging the limiting mechanism, excessive axial float of the connector 2 between the reduction gearbox interface 1 and the plunger pump device interface 3 can be prevented.

Although the connector 2 is used as an example to describe a case in which the limiting mechanism is arranged in the form of an L-shaped plate, the limiting mechanism in the form of an L-shaped plate may also be appropriately applied to a connector in another example or variant. Because the operating mechanism is exactly the same, a detailed description will not be provided herein.

The foregoing describes an example in which axial displacement of the connector is limited by arranging the limiting mechanism in the middle of the connector, but axial displacement of the connector may also be limited by arranging the limiting mechanism on both sides of the connector.

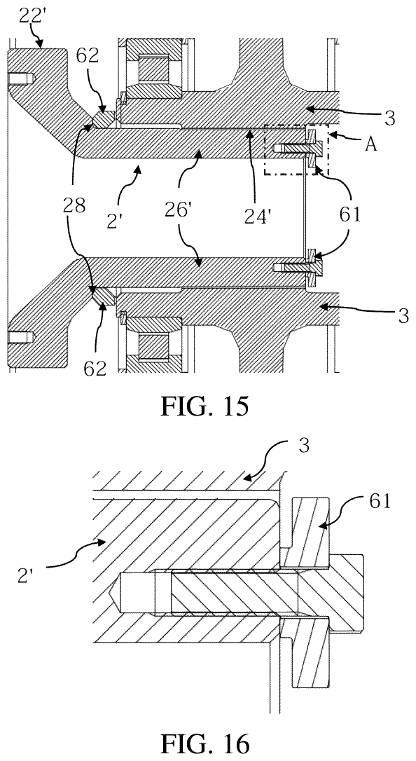

FIG. 15 is a cross-sectional view of the connector 2′ shown in FIG. 6 to FIG. 10 in a state of engaging with the reduction gearbox interface (not shown) and the plunger pump device interface 3.

As shown in FIG. 15, one or more stepped members 61 are fastened at the right end portion of the connector 2′ (specifically, the end portion of the plunger pump device interface side), so as to limit leftward displacement of the connector 2′ in the axial direction. As shown in FIG. 6, two stepped members 61 can be seen. For example, the stepped members 61 may be tightened in threaded holes arranged on a side circumference of the end portion of the connector 2′ by using bolts. Certainly, fastening of the stepped members 61 on the connector 2′ is not limited to using screws, or may be removably connected or fastened in another manner.

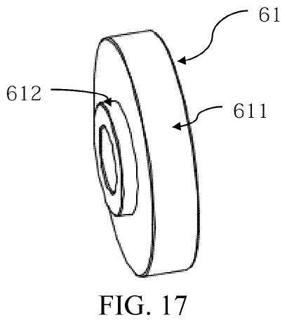

FIG. 16 is a partially enlarged view of a part A of FIG. 15.

In addition, one or more auxiliary limiting members 62 are arranged at the left end portion of the connector 2′ (specifically, the end portion of the reduction gearbox interface side of the connector 2′), so as to limit rightward displacement of the connector 2′ in the axial direction. Specifically, a step 28 is arranged at a transition portion between the shaft 26′ of the connector 2′ and the end portion of the reduction gearbox interface side, so that the step 28 forms a notch together with the plunger pump device interface 3, so as to accommodate the auxiliary limiting member 62. In FIG. 6, the left end portion of the auxiliary limiting member 62 abuts against the step 28, and the right end portion thereof abuts against the plunger pump device interface 3, so that rightward displacement of the connector 2′ in the axial direction can be limited.

A limiting effect similar to that of the limiting mechanism in the fourth embodiment can be implemented under the joint action of the stepped member 61 and the auxiliary limiting member 62.

FIG. 17 shows a separate stepped member 61. As shown in the figure, the stepped member 61 includes a body 611 and a stepped portion 612 having a radial size smaller than that of the body 611. The axial thickness of the stepped portion 612 may be, for example, set to 2 mm to 8 mm, thereby implementing an allowable axial displacement amount of, for example, 2 mm to 8 mm of the connector 2′.

By arranging the limiting mechanism including the stepped member 61 and the auxiliary limiting member 62, excessive axial float of the connector 2′ between the reduction gearbox interface 1 and the plunger pump device interface 3 can be prevented.

Although the connector 2′ is used as an example to describe a case in which the limiting mechanism including the stepped member 61 and the auxiliary limiting member 62 is arranged, the limiting mechanism including the stepped member 61 and the auxiliary limiting member 62 may also be appropriately applied to a connector in another example and variant. Because the operating mechanism is exactly the same, a detailed description will not be provided herein.

The foregoing descriptions are merely preferred embodiments of the present disclosure, and are not intended to limit the present disclosure. For a person skilled in the art, various changes and variations may be made to the present disclosure. Any modification, equivalent replacement, or improvement made without departing from the spirit and principle of the present disclosure shall fall within the protection scope of the present disclosure.

1. A connection system for a plunger pump device, comprising:
a connector, comprising a shaft and a first engaging portion and a second engaging portion provided at opposite end portions of the shaft;
a reduction gearbox interface, comprising a third engaging portion; and
a plunger pump device interface, comprising a fourth engaging portion, wherein:
the first engaging portion engages with the third engaging portion to form a first engaging pair, and the second engaging portion engages with the fourth engaging portion to form a second engaging pair,
the first engaging portion and the third engaging portion are respectively internal teeth and external teeth of the first engaging pair, or are respectively external teeth and internal teeth of the first engaging pair,
the second engaging portion and the fourth engaging portion are respectively internal teeth and external teeth of the second engaging pair, or are respectively external teeth and internal teeth of the second engaging pair,
the external teeth or the internal teeth of the first engaging pair are configured as crowned teeth, and/or the external teeth or the internal teeth of the second engaging pair are configured as crowned teeth, and
other external teeth and internal teeth of the first engaging pair and the second engaging pair are configured as straight teeth.

2. The connection system according to claim 1, wherein a size of the second engaging portion is configured for a reduction gearbox with specific power.

3. The connection system according to claim 1, wherein the shaft is configured in a form of a straight shaft or a stepped shaft.

4. The connection system according to claim 1, wherein the shaft is configured as a hollow shaft having an axial through hole.

5. The connection system according to claim 1, further comprising a limiting mechanism fastened to one or both of the plunger pump device interface and the reduction gearbox interface to limit axial displacement of the connector between the plunger pump device interface and the reduction gearbox interface.

6. The connection system according to claim 5, wherein:
the limiting mechanism is an L-shaped plate and comprises a first leg and a second leg perpendicular to the first leg,
the shaft is provided with a notch on a periphery,
the first leg is fastened to one or both of the plunger pump device interface and the reduction gearbox interface, and
the second leg is accommodated in the notch to limit bidirectional displacement of the connector in an axial direction.

7. The connection system according to claim 6, wherein an axial size of the notch is configured to be greater than an axial size of the second leg to provide an allowable axial displacement amount of the connector.

8. The connection system according to claim 1, further comprising a limiting mechanism, wherein:
the limiting mechanism comprises a stepped member and an auxiliary limiting member,
the stepped member is fastened to a first end portion of the connector to limit displacement of the connector in a first direction of an axial direction, and
the auxiliary limiting member is fastened to a second end portion of the connector opposite to the first end portion to limit displacement of the connector in a second direction of the axial direction.

9. The connection system according to claim 8, wherein:
the stepped member comprises a body and a stepped portion having a radial size smaller than that of the body, and the stepped portion is configured to have a specific axial thickness to provide an allowable axial displacement amount of the connector.

10. The connection system according to claim 7, wherein the allowable axial displacement amount is 2 mm to 8 mm.

11. The connection system according to claim 5, wherein the allowable axial displacement amount is 2 mm to 8 mm.

12. The connection system according to claim 1, wherein the plunger pump device interface is a crankcase interface provided on a crankcase of the plunger pump device.

13. The connection system according to claim 1, further comprising a limiting mechanism to limit axial displacement of the connector between the plunger pump device interface and the reduction gearbox interface.

14. The connection system according to claim 13, wherein the allowable axial displacement amount is 2 mm to 8 mm.
